(19) United States
(12) Patent Application Publication
(10) Pub. No.: US 2010/0115336 A1
(43) Pub. Date: May 6, 2010

(54) MODULE TEST DEVICE AND TEST SYSTEM INCLUDING THE SAME

(75) Inventors: Dong-Eun SHIN, Asan-si (KR); Jungkuk LEE, Yongin-si (KR); Junjung PARK, Cheonan-si (KR); Deogjong HWANG, Cheongju-si (KR); Jae Chun YOU, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/609,263

(22) Filed: Oct. 30, 2009

(30) Foreign Application Priority Data
Nov. 4, 2008 (KR) 2008-108960

(51) Int. Cl. G06F 11/273

(52) U.S. Cl. 714/27; 714/E11.17

(57) ABSTRACT

A test system includes a host, a module to communicate with the host, and a test device to test the module while the module is connected to the host. The host includes a pulse width modulator circuit to supply a power to the module, and the test device varies a feedback resistance value provided to the pulse width modulator circuit.

### CROSS-REFERENCE TO RELATED APPLICATIONS

This U.S. non-provisional patent application claims priority under 35 U.S.C. §119 of Korean Patent Application No. 10-2008-0108960 filed on Nov. 4, 2008, the entirety of which is hereby incorporated by reference.

### BACKGROUND

1. Field of the Invention

The present general inventive concept relates to a module test device and a test system including the same.

2. Description of the Related Art

A computing system may include a plurality of elements, such as a power supply, a display device, an image signal processing device, a storage device, a CPU, and so on. Each element may be in a module form. For example, to exchange a data storage device in the computing system, an old data storage device is disconnected from an interface (for example, IDE device, ATA device, DIMM device, or the like), and then a new data storage device is connected to the interface.

The elements of the computing system may be made by different manufacturers. Thus, although memory modules (for example, 16 Gbyte DDR2) may have the same capacity and module format, their operating characteristics may be different. For this reason, elements with different operating characteristics may conflict with one another. To prevent the above-described conflict, the elements of the computing system may be tested while mounted on the computing system.

### SUMMARY

Exemplary embodiments of the present general inventive concept may provide a test device and test system capable of reducing errors and power consumption in a computing system.

Additional aspects and utilities of the present general inventive concept will be set forth in part in the description which follows and, in part, will be obvious from the description, or may be learned by practice of the general inventive concept.

Features and/or utilities of the present general inventive concept may be realized by a test system including a host, a module to communicate with the host, and a test device to test the module. The host may include a pulse width modulator circuit to supply power to the module, and the test device may vary a feedback resistance value provided to the pulse width modulator circuit.

Additional features and/or utilities of the present general inventive concept may also be realized by a test device including a variable resistance part and a controller to vary a resistance value of the variable resistance part. The variable resistance part may be connected to a feedback terminal of an external pulse width modulator circuit used as a power supply and may vary an output of the external pulse width modulator circuit.

Additional features and/or utilities of the present general inventive concept may also be realized by a host device including a connector to connect an operational module to the host device, a test terminal to connect to an external test device, and a power supply to supply a variable power signal to the operational module based on resistance values supplied to the power supply from the external test device.

The power supply may include a feedback circuit, and the external test device may vary resistance values of the feedback circuit to change a value of the variable power signal to the operational module.

The external device may include a feedback circuit, and the external test device may vary resistance values of the feedback circuit to change a value of the variable power signal to the operational module.

The host device may include a power output terminal to supply power to the external test device.

The host device may include at least one processor to communicate with the operational module.

The connector may be one of a USB, MMC, PCI-E, Accelerated Graphic Port, Advanced Technology Attachment, Serial-ATA, Parallel-ATA, SCSI, ESDI, Integrated Drive Electronics, Double In-line Memory Module, and a Single In-line Memory Module connector.

Additional features and/or utilities of the present general inventive concept may also be realized by a testing device including at least one variable resistor, a variable resistance controller to adjust a resistance of the at least one variable resistor, and an output terminal to connect to a testing terminal of a host device. The variable resistance controller may vary the variable resistance value provided to the host device by varying the resistance value of the at least one variable resistor.

The testing device may include memory, and the variable resistance controller may vary the resistance value of the at least one variable resistor by accessing a predetermined pattern of resistance values in memory.

The testing device may include a random number generation unit to generate random numbers within a predetermined range, and the variable resistance controller may vary the resistance value of the at least one variable resistor according to random numbers generated by the random number generation unit.

The testing device may include a power terminal to receive power from the host device.

Additional features and/or utilities of the present general inventive concept may also be realized by a test system including a host device including a power supply, a connector, and a testing terminal, an operational module to connect to the connector, and a testing device to connect to the testing terminal. The power supply of the host device may supply a power signal to the operational module, the testing device may provide a variable resistance value to the host device via the testing terminal, and the testing device may vary a value of the power signal to the operational module by varying the variable resistance value provided to the host device.

The power supply may include a pulse width modulation circuit having a feedback input terminal, the testing terminal may be connected to the feedback input terminal, and the testing device may vary the value of the power signal to the operation module by varying the variable resistance value provided to the feedback input terminal of the pulse width modulation circuit.

The power supply may include a smoothing circuit to smooth a signal output from the pulse width modulator and to output a smoothed signal as the power signal to the operational module.

The power supply may include an output line to output the power signal to the operational module, and the output line may be connected to the feedback input terminal of the pulse width modulator via at least one feedback resistor.

The testing device may include at least one variable resistor, and the at least one feedback resistor may include only the at least one variable resistor of the testing device.

The testing device may include at least one variable resistor, the power supply may include a voltage divider circuit, and the at least one feedback resistor may includes the at least one variable resistor of the testing device connected in parallel with at least one resistor of the voltage divider circuit.

Additional features and/or utilities of the present general inventive concept may also be realized by a method to supply variable power to an operational module, the method including varying a resistance of a feedback circuit connected to an input of a pulse width modulator while the operational module is connected to an output of the pulse width modulator, adjusting a pulse width of a first signal output from the pulse width modulator according to the varied resistance of the feedback circuit, and outputting the first signal to the operational module and to the feedback circuit.

The method may include smoothing the first signal with a smoothing circuit before outputting the first signal to the operational module and the feedback circuit.

Varying the resistance of the feedback circuit may include adjusting a resistance value of a variable resistor of the feedback circuit.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram showing a test system according to one embodiment of the present general inventive concept.

FIG. 2 is a block diagram showing a module power supply, a connector, and a module illustrated in FIG. 1;

FIG. 3 is a block diagram showing a module power supply, a connector, a module, and a test device according to an embodiment of the present general inventive concept;

FIG. 4 is a block diagram showing a module power supply, a connector, a module, and a test device according to an embodiment of the present general inventive concept; and

FIG. 5 is a flowchart showing a test method according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

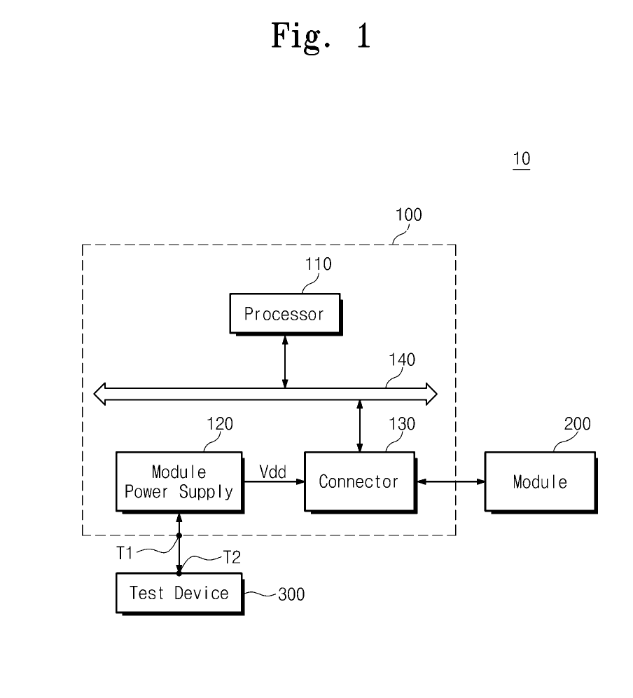

FIG. 1 is a block diagram showing a test system 10 according to an embodiment of the present general inventive concept. The test system 10 may include a host or host device 100, a module 200, and a test device 300.

The host 100 may have one or more terminals T1 to connect to the test device 300, and the test device 300 may have one or more terminals T2 to connect to the host 100. The terminals T1, T2 may transmit communication signals, voltages, and power signals. For example, the host 100 may supply power to the test device 300 to run the test device 300.

The host 100 may include a processor 110, a module power supply 120, a connector 130, and a system bus 140. The processor 110 may control an operation of the host 100. The module power supply 120 supplies module power Vdd to the module 200 via the connector 130. Further, the connector 130 connects the module 200 to the system bus 140.

The module 140 may include memory, audio, video, or any other operational device and may be configured to utilize various interfaces such as USB, MMC, PCI-E, Accelerated Graphic Port (AGP), Advanced Technology Attachment (ATA), Serial-ATA, Parallel-ATA, SCSI, ESDI, Integrated Drive Electronics (IDE), Double In-line Memory Module (DIMM), Single In-line Memory Module (SIMM), and the like. The module 200 communicates with the system bus 140 via the connector 130. The connector 130 may be include interconnection means, such as slots, cables, sockets, bonding, or other connectors to connect the module 200 to the host 100.

Although FIG. 1 illustrates the host 100 having a processor 110, a module power supply 120, and a connector 130, the host is not limited to this configuration. For example, the host 100 may include additional elements to conduct given operations.

The host 100 may be one of various electronic devices such as personal computers, notebook computers, workstations, PDAs, portable computers, web tablets, wireless phones, mobile phones, digital music players, devices to transmit and receive information in a wireless environment, digital cameras, household game machines, and other devices.

As discussed above, the module 200 may be a memory module or other operational module. When the module 200 is a memory module, it may include a volatile memory such as SRAM, DRAM, SDRA, or the like. The module 200 may include nonvolatile memory such as ROM, PROM, EPROM, EEPROM, a flash memory device, PRAM, MRAM, RRAM, FRAM, or the like. The module 200 may be a memory card such as PC card (PCMCIA), CF card, SM/SMC, a memory stick, MMC, RS-MMC, MMCmicro, SD, miniSD, microSD, UFS, or the like. The module 200 may be a data storage device such as an ODD, HDD, SSD, or the like. The host 100 may be a main board, and the module 200 may be a memory (for example, DRAM) connected to the main board.

The scope of the present general inventive concept is not limited to the above types of host 100 and module 200 and an interface between the host 100 and the module 200. The scope of the present general inventive concept can be applied to all systems in which a host 100 supplies a power to a module 200.

In FIG. 1, the connector 130 is connected to the system bus 140. But the connector 130 may be directly connected with one of elements of the host 100 instead of the system bus 140. For example, the connector 130 may be directly connected to the processor 110.

The test device 300 is connected to the module power supply 120 of the host 100. The test device 300 controls the module power supply 120 to change the module power output signal Vdd. While the host 120 drives the module 200, the test device 300 controls the module power supply 120 to change the module power Vdd. That is, the host 100, the module 200, and the test device 300 together form the test system 10, in particular, the mount test system 10.

The test system 10 is configured such that the host 100 judges whether the module 200 is operating normally. The host 100 and the module 200 may perform normal operations such as data storing and processing operations. The test device 300 may control the module power supply 120 of the host 100 to change the module power Vdd. That is, the test system 10 determines whether the module 200 is operating normally when the module power Vdd is unstable.

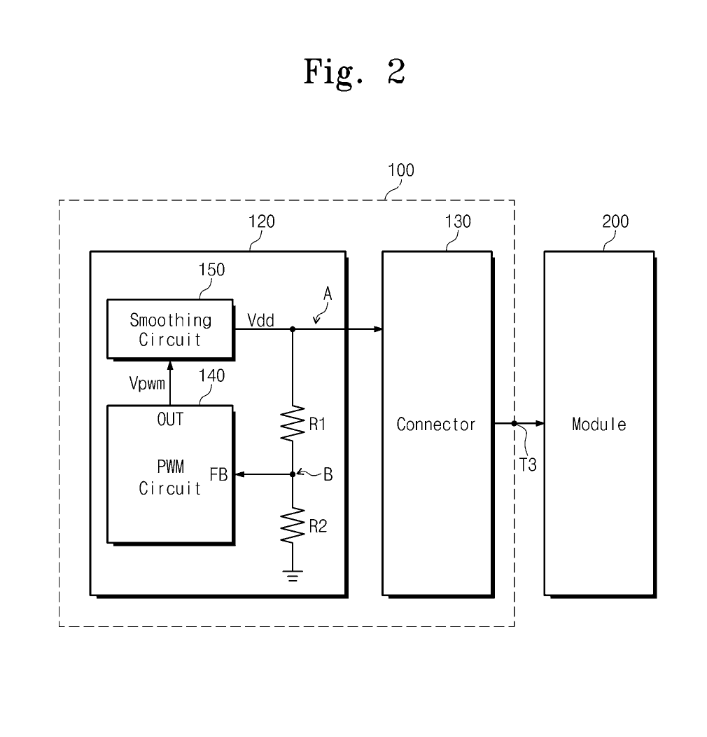

FIG. 2 is a block diagram showing a module power supply 120, a connector 130, and a module 200 illustrated in FIG. 1. The module power supply 120 may include a pulse width modulator circuit 140, a smoothing circuit 150, and resistors R1 and R2.

The pulse width modulator circuit 140 modulates a pulse width of an output pulse Vpwm via an output terminal OUT in response to a voltage received at a feedback terminal FB. If a voltage received at the feedback terminal FB is higher than a given voltage, the pulse width modulator circuit 140 modulates the output pulse Vpwm so that its pulse width narrows. If the voltage received at the feedback terminal FB is lower than the given voltage, the pulse width modulator circuit 140 modulates the output pulse Vpwm so that its pulse width widens.

The smoothing circuit 150 smoothes the output pulse Vpwm of the pulse width modulator circuit 140 to output the smoothed result as a module power Vdd. The smoothing circuit 150 may be formed of well-known elements such as capacitors, inductors, and so on. The module power Vdd is provided to the module 200 via the connector 130. The module power Vdd is connected to a feedback circuit to provide a voltage to the feedback terminal FB of the pulse width modulator circuit 140. The feedback circuit may include a divider circuit including resistors R1 and R2. The module power Vdd may be divided by the resistors R1 and R2, and a voltage on a node B between the resistors R1 and R2 may be supplied to the feedback terminal FB of the pulse width modulator circuit 140.

The pulse width modulator circuit 140, the smoothing circuit 150, and the feedback resistors R1 and R2 together form a feedback loop. If a voltage divided by the feedback resistors R1 and R2, that is, a divided voltage of the module power Vdd, is higher than a given voltage, the pulse width modulator circuit 140 modulates the output pulse Vpwm so that its pulse width narrows. Narrowing the pulse width output signal lowers the module power Vdd, which in turn reduces the divided voltage to input to the feedback terminal FB of the pulse width modulator circuit 140.

On the other hand, if the divided voltage is lower than a given voltage, the pulse width modulator circuit 140 modulates the output pulse Vpwm so that its pulse width widens, increasing the module power Vdd and the divided voltage.

To test the module 200 connected to the host 100 via terminal T3 of the connector 130, the module power Vdd supplied to the module 200 is changed. Changing the module power Vdd may be done via a number of methods.

According to one method, the module 200 may be disconnected from the module power supply 120 and a test device (not shown) may provide power to the module. For example, node A may be disconnected from the connector 130, and the test device (not shown) may be connected to the connector 130 to supply power to the module 200 via the connector.

However, in the above method, a wire that connects the test device (not shown) to the connector 130 may generate noise. The noise may increase a rate of variation of the module power signal compared to a desired variation. Rapid variation of the module power may cause communication between the host 100 and the module 200 to halt, which would result in a failed test of the module.

In addition, the noise may cause an increased variation of module power, which could result in a failed test of the module 200.

In other words, connecting a wire to the module 200 via the connector 130 to supply power to the module 200 may result in a decreased yield of modules, since more modules 200 are likely to fail testing.

According to another method, a variable module power may be supplied to the module 200 by varying the module power Vdd. The module power Vdd may be varied by adjusting a voltage difference between the nodes A and B to control a pulse width of the output pulse Vpwm. For example, the nodes A and B may be connected to a test device (not shown) via corresponding wires, respectively. The test device may supply the node B with a voltage that is either lower than or higher than the voltage supplied to the node A. By varying the voltage supplied to node B, which is connected to the feedback terminal FB of the pulse width modulation circuit 140, the test device (not shown) also varies the module power Vdd.

For example, the feedback terminal FB is supplied with a voltage (that is, a divided voltage) obtained by dividing the module power Vdd via the feedback resistors R1 and R2. In addition, the test device (not shown) supplies a voltage corresponding to a difference between the module power Vdd and the varied voltage to the feedback terminal FB from the test device.

However, the above method may cause the module power supply 120 to halt due to conflict between a voltage supplied to the feedback terminal FB from the test device and the divided voltage (obtained by dividing the module power Vdd via the feedback resistors R1 and R2) supplied to the feedback terminal FB. If the module power supply 120 halts, the module 200 fails its testing. As a result, the above method may result in reduced yields of modules 200 that pass testing.

To solve the above-described shortcomings, a test system may include a host, a module to communicate with the host, and a test device to test the module. The host may include a pulse width modulator circuit to provide a power to the module, and the test device may vary a resistance value of feedback resistors connected to the pulse width modulator circuit. Below, embodiments of the present general inventive concept will be more fully described with reference to accompanying drawings.

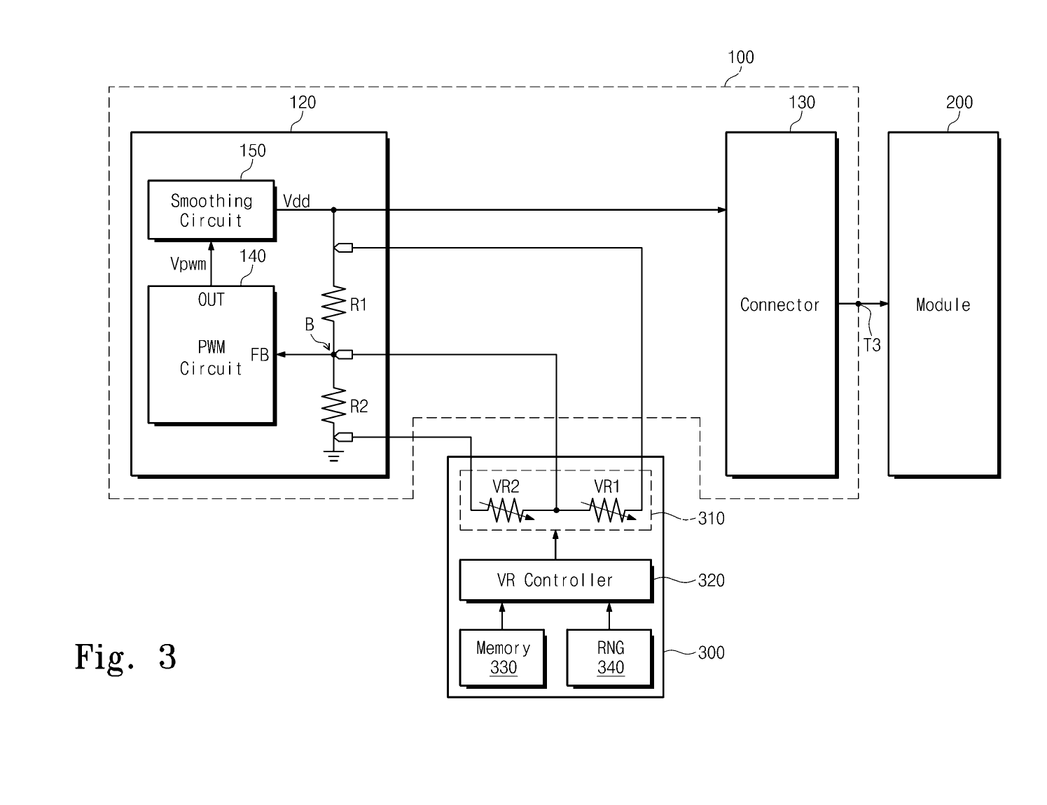

FIG. 3 is a block diagram showing a module power supply 120, a connector 130, and a test device 300 according to an embodiment of the present general inventive concept. The elements 120, 130, and 300 are similar to those illustrated in FIG. 2.

The test device 300 may include a variable resistance part 310 and a variable resistance controller 320. The variable resistance part 310 may include variable resistors VR1 and VR2. The variable resistance controller 320 may be configured to control resistance values of the variable resistors VR1 and VR2. The variable resistors VR1 and VR2 are connected to a feedback terminal FB of the pulse width modulator circuit 140. The feedback terminal FB provides power to the pulse width modulator circuit 140 and varies an output of the pulse width modulator circuit 140.

The variable resistance controller 320 may vary the resistances of the variable resistors VR1, VR2 according to a predetermined set of resistance values stored in memory 330, based on random values within a predetermined range generated by a random number generation unit 340, or from control signals from an external source (not shown), for example.

The variable resistors VR1 and VR2 may be connected in parallel with resistors R1 and R2, respectively. The resistor R1 and the variable resistor VR1 may form a feedback resistor above the node B, and the resistor R2 and the variable resistor VR2 may form a feedback resistor below the node B. When resistance values of the variable resistors VR1 and VR2 are changed by the variable resistance controller 320, the resistance values of the feedback resistors (R1 and VR1) and (R2 and VR2) connected to the feedback terminal FB of the pulse width modulator circuit 140 also change.

The pulse width modulator circuit 140 outputs a given pulse width modulation signal based on the module power output signal Vdd divided by the feedback resistors (R1 and VR1) and (R2 and VR2). When the resistance values of the feedback resistors (R1 and VR1) and (R2 and VR2) change as a result of changes of resistance values of the variable resistors VR1 and VR2, the divided module power output signal voltage Vdd changes, and the divided voltage is transmitted to the feedback FB. The changed divided module power voltage causes the pulse width modulator circuit 140 to change a pulse width of an output pulse Vpwm which, in turn, changes the module power voltage Vdd. In other words, when the test device 300 varies the resistance of the feedback resistors (R1 and VR1) and (R2 and VR2), the module power Vdd to a module 200 also changes.

For example, the variable resistance controller 320 may cause the variable resistors VR1 and VR2 to have given values. The variable resistance controller 320 may be programmed to vary resistance values of the variable resistors VR1 and VR2 to given values. The variable resistance controller 320 may sequentially change a resistance value of each of the variable resistors VR1 and VR2 to a first value, a second value, a third value, and so on. The resistance values of the variable resistors VR1 and VR2 may vary randomly or according to a predetermined order.

Alternatively, the variable resistance controller 320 may vary resistance values of the variable resistors VR1 and VR2 in response to external control signals. In other words, a device external to the variable resistor controller 320 or to the test device 300 may provide control signals to the variable resistor controller 320 to change the resistance values of the variable resistors VR1 and VR2 to certain values.

As described above, the test device 300 and the test system 100 may change a module power Vdd supplied to a module 200 by varying a feedback resistance value (that is, a resistance value of a node B as detected by the pulse width modulator circuit 140) of a feedback circuit connected to a pulse width modulator circuit 140. Since the module power signal voltage Vdd is supplied to the module 200 using the module power supply 120 of the host 100, no conflict arises between the module power supply 120 and the test device 300.

In addition, since the test device 300 does not supply a variable module power Vdd or a voltage to vary a module power Vdd via a cable, there is no noise due to such a cable and the yield of the memory module 200 may be improved.

In addition, since the test device 300 does not generate a variable module power Vdd or a voltage to vary a module power Vdd, the power consumption of the test device 300 may be reduced.

During a test operation, the host 100 may supply power to the test device 300. If the power consumption of the test device 300 exceeds a power supply range of a power supply in the host 100, the test system 10 may halt, and the module would fail the test. Since the method described above would reduce power consumption of the test system 10, the yield of the module 200 may be increased. In other words, more modules 200 would pass the test.

Although FIG. 3 illustrates a variable resistance part 310 that includes a variable resistor VR1 connected with a resistor R1 over a feedback terminal FB (or, a node B) and a variable resistor VR2 connected with a resistor R2 below the feedback terminal FB (or, the node B), the variable resistance part 310 is not limited to this disclosure. For example, the variable resistance part 310 may be configured to include any one of the variable resistors VR1 and VR2.

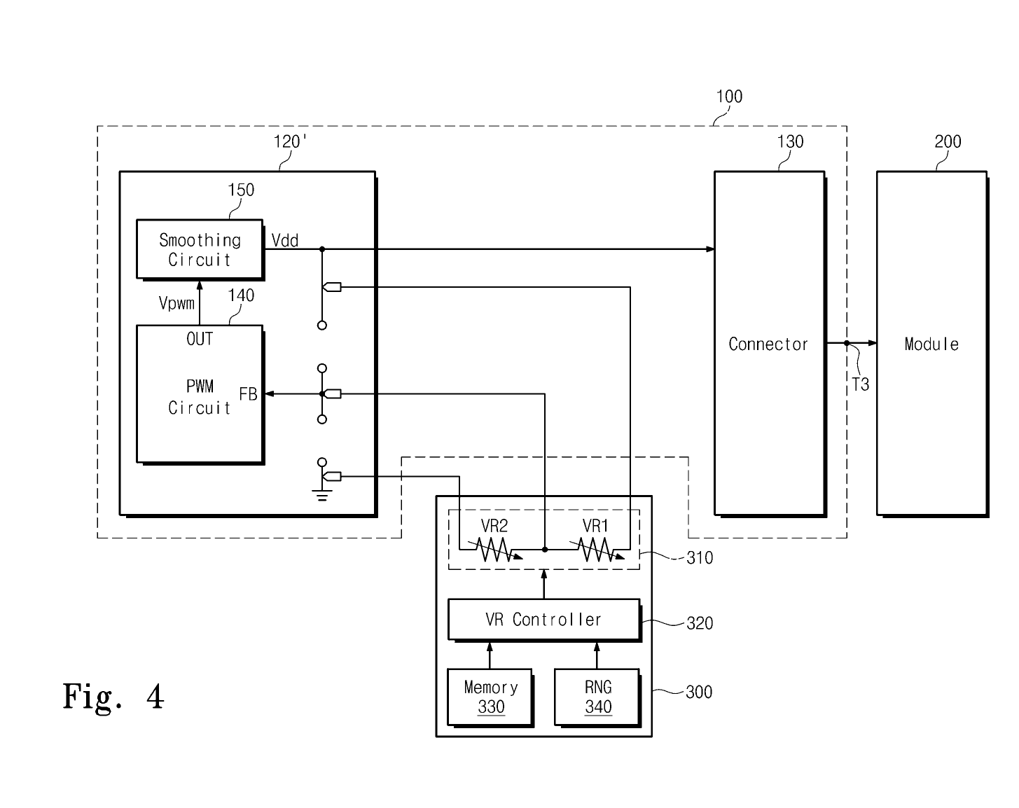

FIG. 4 is a block diagram showing a module power supply 120′, a connector 130, a module 200, and a test device 300 according to an embodiment of the present general inventive concept. The elements 130, 200, and 300 in FIG. 4 are similar to those illustrated in FIG. 3. The module power supply 120′ is similar to module power supply 120 in FIG. 3 except that resistors R1 and R2 in FIG. 3 are omitted from module power supply 120′.

Compared to the module power supply 120 described in FIG. 3, the module power supply 120′ does not include resistors R1 and R2 (refer to FIG. 3) connected to the feedback terminal FB of the pulse width modulator circuit 140. Instead, variable resistors VR1 and VR2 are connected to the feedback terminal FB of the pulse width modulator circuit 140. Each of the variable resistors VR1 and VR2 form a feedback resistor of the pulse width modulator circuit 140.

The variable resistance controller 320 changes resistance values of the variable resistors, or feedback resistors, VR1 and VR2. If resistance values of the feedback resistors are changed, a voltage transferred to the feedback terminal FB of the pulse width modulator circuit 140 is changed. Thus, the pulse width modulator circuit 140 changes a pulse width of an output pulse Vpwm, and a level of a module power Vdd is changed.

Since the module power Vdd is changed by changing resistance values of feedback resistors connected with the pulse width modulator circuit 140, power consumption of the test device 300 and the test system 10 may be reduced, and the yield of the module 200 may be improved.

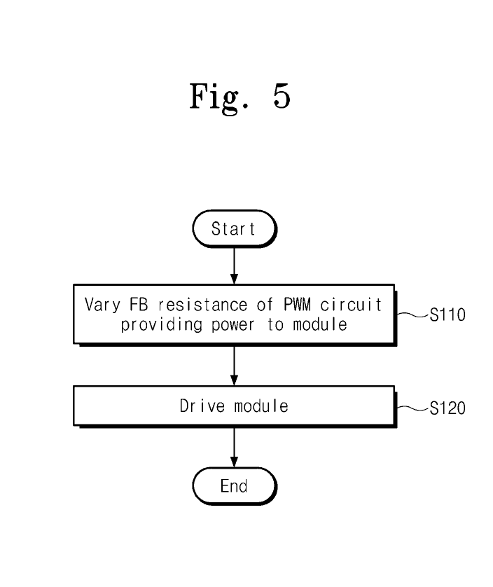

FIG. 5 is a flowchart illustrating a test method according to an embodiment of the present general inventive concept. Referring to FIGS. 3 to 5, in operation S110, the resistance values are changed of feedback resistors connected with a pulse width modulator circuit 140 to supply a power to a module 200. The feedback resistors may be variable resistors VR1 and VR2 of a test device 300 connected to the feedback terminal FB of the pulse width modulator circuit 140. The feedback resistors may also be variable resistors VR1 and VR2 connected in parallel with resistors R1 and R2 connected to the feedback terminal FB of the pulse width modulator circuit 140.

The variable resistance controller 320 may vary resistance values of the variable resistors VR1 and VR2. If the resistance values of the variable resistors VR1 and VR2 are changed, a feedback resistance value of the pulse width modulator circuit 140 may also change. When the feedback resistance value of the pulse width modulator circuit 140 changes, a module power Vdd provided to the module 200 also changes.

In operation S120, the module power supply 120 drives the module 200 by providing a variable module power Vdd to the module 200. For example, if the module 200 is a memory device, write, read, and erase operations may be performed while the variable module power Vdd is supplied to the module 200. If the module 200 is an electronic device designed to perform a given operation, the given operation of the module 200 is performed while the variable module power Vdd is supplied to the module 200.

Since the module 200 is driven while receiving the variable module power Vdd, it is possible to determine whether the module 200 operates normally when a module power Vdd supplied from the host 100 to the module 200 is unstable.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A test system comprising:
a host device including a pulse width modulator circuit;
a module to communicate with the host device and to receive power from the pulse width modulator circuit; and
a test device to test the module while the module communicates with the host device,
wherein the test device varies a feedback resistance value of a feedback circuit connected to the pulse width modulator circuit according to the power supplied to the module.

2. The test system of claim 1, wherein the test device includes a variable resistor connected to a feedback terminal of the pulse width modulator circuit.

3. The test system of claim 2, wherein the variable resistor is connected in parallel with a resistor connected to the feedback terminal of the pulse width modulator circuit.

4. The test system of claim 2, wherein the feedback terminal of the pulse width modulator is connected to only the variable resistor of the test device.

5. The test system of claim 1, wherein the test device receives power from the host device.

6. The test system of claim 1, wherein the feedback circuit comprises a voltage divider connected to a power output to the module such that the divided voltage is transmitted to a feedback terminal of the pulse width modulator circuit.

7. The test system of claim 1, wherein the host further comprises a smoothing circuit to smooth an output of the pulse width modulator circuit to supply the smoothed result to the module as power, and
the output voltage of the smoothing circuit is divided by a voltage divider in the feedback circuit and the divided result is transmitted to a feedback terminal of the pulse width modulator circuit.

8. A test device, comprising:
a variable resistance part; and
a controller to vary a resistance value of the variable resistance part,
wherein the variable resistance part is connected to a feedback terminal of a pulse width modulator circuit to control a power signal supplied to a module, the pulse width modulator being external to the test device, and
the resistance value of the variable resistance part varies a power signal output from the pulse width modulator circuit.

9. The test device of claim 8, wherein the controller varies the resistance value of the variable resistance part to a predetermined value.

10. The test device of claim 8, wherein the controller varies the resistance value of the variable resistance part in response to externally provided control signals.

11. A method to supply variable power to an operational module, the method comprising:
varying a resistance of a feedback circuit connected to an input of a pulse width modulator while the operational module is connected to an output of the pulse width modulator;
adjusting a pulse width of a first signal output from the pulse width modulator according to the varied resistance of the feedback circuit; and
outputting the first signal to the operational module and to the feedback circuit.

12. The method according to claim 11, further comprising:
smoothing the first signal with a smoothing circuit before outputting the first signal to the operational module and the feedback circuit.

13. The method according to claim 11, wherein varying the resistance of the feedback circuit comprises adjusting a resistance value of a variable resistor of the feedback circuit.
